(19) United States
(12) Patent Application Publication
(10) Pub. No.: US 2004/0041428 A1
(43) Pub. Date: Mar. 4, 2004

(54) Absorptive automobile coverings

(76) Inventor: Graham Tompson, Northville, MI (US)

Correspondence Address: MYERS BIGEL SIBLEY & SAJOVEC, PO BOX 37428, RALEIGH, NC, 27627, US

(21) Appl. No.: 10/297,507

(22) PCT Filed: Jun. 8, 2001
(86) PCT No.: PCT/US01/18526

(30) Foreign Application Priority Data
Jun. 9, 2000 (GB) 0014171.3

(51) Int. Cl. B62D 25/00

(52) U.S. Cl. 296/39.3

(57) ABSTRACT

A member (10) which is used for the interior panelling of vehicles which can change the acoustic properties of the interior of the vehicle. The member comprises a panel (12) with a plurality of through-holes (14) formed therein and a covering (16) of absorptive material covering one surface of the panel and the through-holes.

The present invention relates to a method and apparatus for changing the acoustic properties of the inside of an enclosure. The apparatus and method relate particularly to body panels, instrument panels, seats, shelves, floor mats, pillars and centre console areas of vehicles including interior and exterior portions such as the trunk or underbelly which direct noise inside the vehicle.

It is known that sound can be absorbed using a Helmholtz resonator. A Helmholtz resonator is an air-filled cavity with an opening. The sound of a certain frequency can be absorbed by the resonator. The frequency which is absorbed, the so-called resonant frequency, depends on the volume of the cavity and the mass of air which oscillates in the opening.

The inside of vehicles have previously been covered by panels to improve the visual impact and comfort of the inside of the vehicle. Whilst much research effort has centred on producing car audio systems with greater power output and a flatter frequency response, little effort has centred on the frequency response of the interior surface of vehicle cabins.

A means of transport including a passenger space defined by enclosure walls, said means of transport further comprising a panel having a plurality of through-holes formed therein from an outer surface to an inner surface of said panel; said panel being attached to one of said enclosure walls in spaced apart relationship such that said outer surface faces away from said one of said enclosure walls.

In this way the acoustic properties of the inside passenger space of a vehicle can be changed. The panel may be attached inside the passenger space. Thus, because previously used aesthetic panels can be exchanged for the member the weight of the vehicle is not significantly increased and neither is the assembly time. Furthermore, the visual impact of the vehicle to the user need not be impaired.

The panel may also be attached outside of the passenger space. For example, the panel may be attached to the underbelly of the vehicle such that noise from the engine reflected back towards the vehicle by the driving surface, can be absorbed before entering the vehicle.

Driver comfort is improved because the panel absorbs more sound in the audible frequency range than panels of the prior art. Thus the level of engine noises and other road noises can be reduced inside the car by use of the member.

The acoustic performance of the interior of the car can be improved with the present invention. By providing panels with absorption coefficient versus frequency in the audible range flatter than for panels of the prior art the audio output of in-vehicle entertainment is distorted less. Furthermore, overall acoustic performance is improved because the panel has a higher absorption across the audible frequency range resulting in less reflection of sound.

The distribution and size of the holes may be varied to optimise the range of frequencies which are absorbed.

The present invention will be described by way of examples with reference to the accompanying drawings in which:

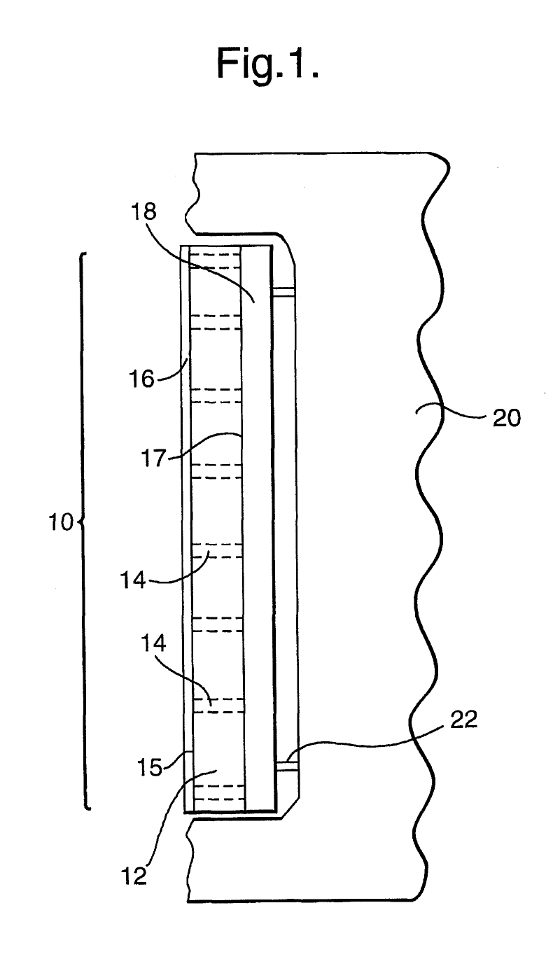

FIG. 1 shows a schematic representation of the cross-section of a member in accordance with the present invention;

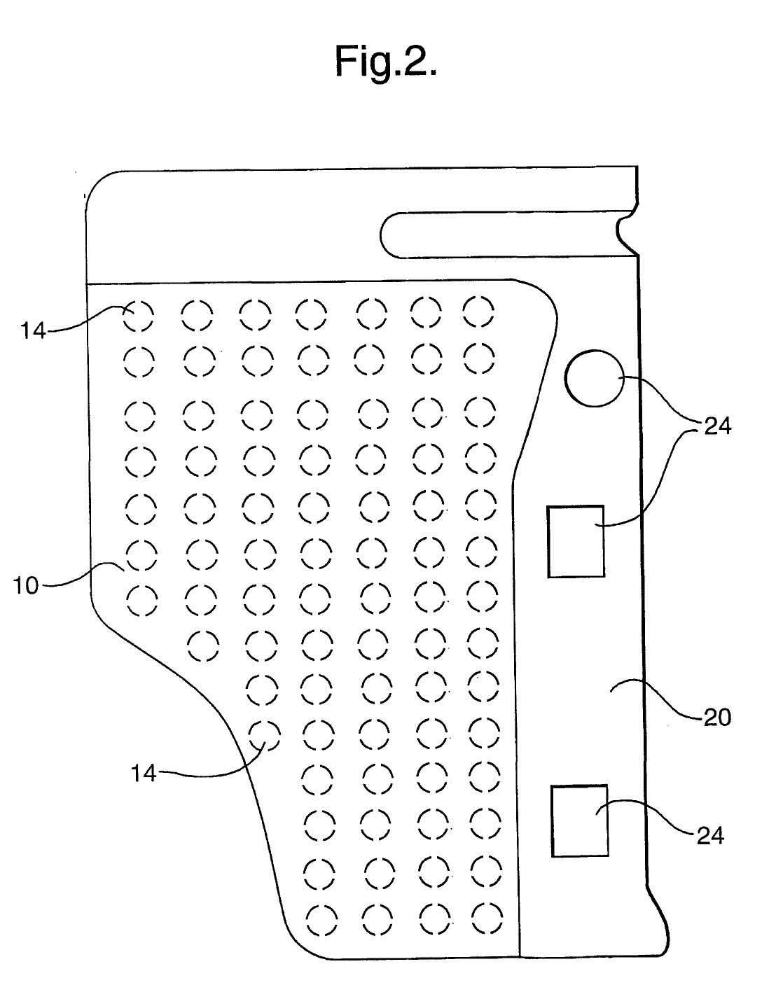

FIG. 2 shows a schematic illustration of a door panel member in accordance with the present invention;

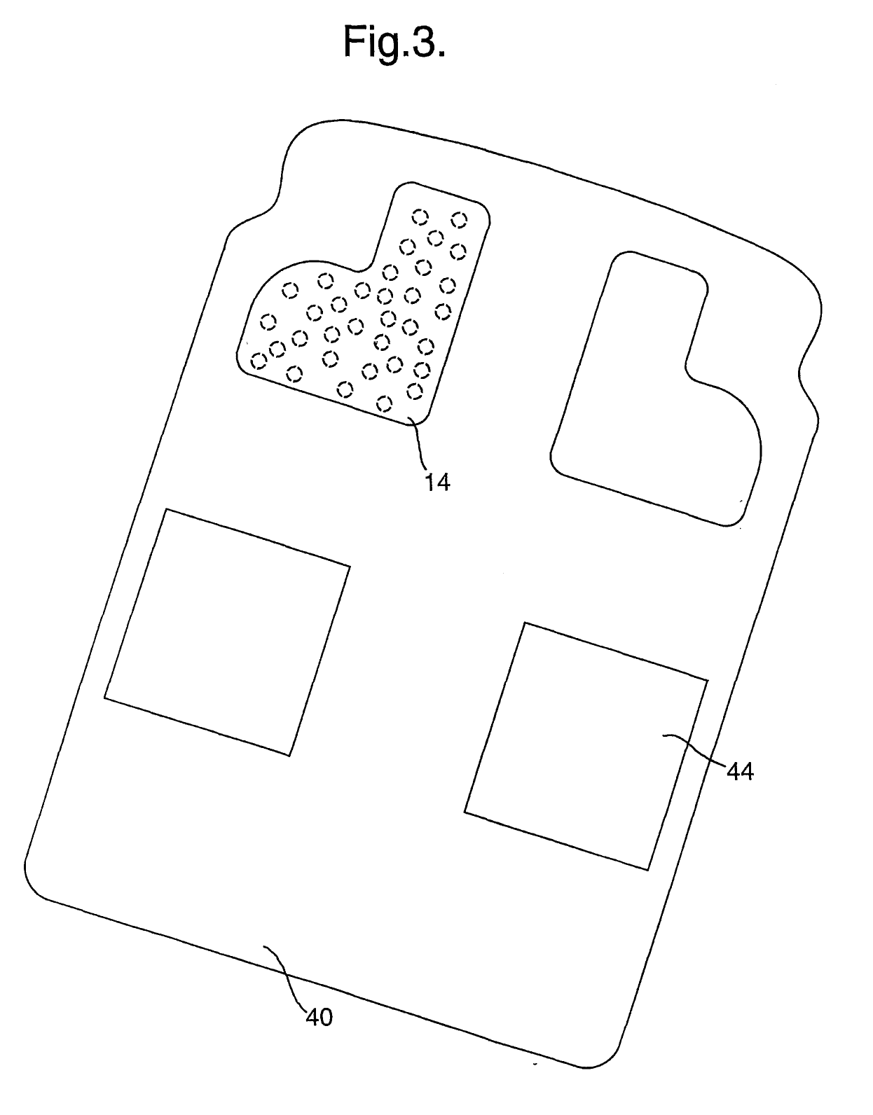

FIG. 3 shows a schematic illustration of an accessory mat member in accordance with the present invention; and

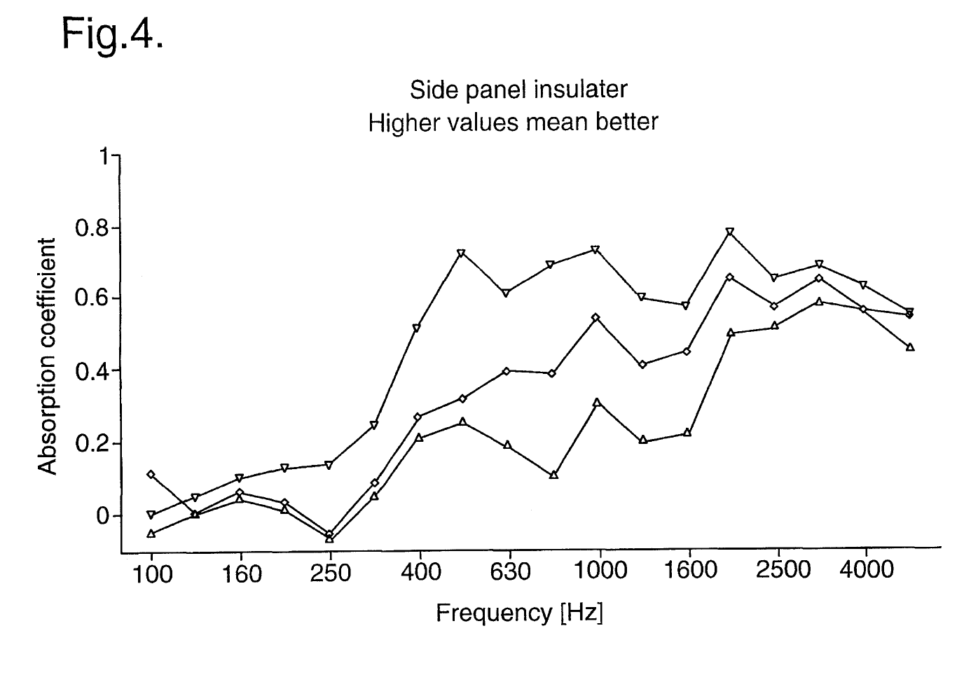

FIG. 4 shows a graph of experimental results showing the variation in absorption coefficient with varying frequency for a door panel in accordance with the present invention and for a standard door panel.

FIG. 1 shows a member 10 according to the present invention. The member comprises a panel 12 with a plurality of through-holes 14 drilled therethrough from an outer surface 15 to an inner surface 17. The panel 12 may be of any material but injection moulded plastics materials and wood are particularly suitable.

The member may be attached in spaced apart relationship to an inner wall of an enclosure to change the acoustic properties of the interior of the enclosure. The space between the panel 12 and the inner wall 20 forms an empty cavity which can optionally be filled by an absorptive material such as open cell foams or mineral wool. Typical enclosures which would benefit from the use of the member 10 are passenger enclosures in means for transport such as aeroplanes, road vehicles, trains, boats etc.

The member may also be attached on the exterior surface of walls of the enclosure such as to the underbelly so that noise from the engine which is reflected back towards the vehicle by the road surface is absorbed before entering the vehicle. By passenger space, we mean any area of the car used by the passenger including, for example, the trunk. Such areas allow noise to enter the passenger seating areas, for example, when rear seat backs are folded down to increase trunk space.

It has been found that the acoustic coefficient is increased further if a covering 16 is placed on the outer surface 15 of the panel 12 to cover the outer surface 15 of the panel and the plurality of through-holes 14. The covering 16 should be of an acoustically absorptive material such as a woven textile fabric and would be approximately 5 millimetres thick. The covering should be porous to the flow of air. A leather or PVC covering with through holes could also be used. Preferably the covering 16 should also be decorative. Typically the covering would be secured (for example by adhesion) only by the edges of its back onto the outer surface 15 of the panel 12.

The diameter, density and spacing of the holes and the number of holes per unit area may be varied. The frequencies which are absorbed by the panel 12 vary according to the diameter and spacing of the holes, the material of which the panel 12 is made and its thickness. Typically, the panel 12 is between 1 and 8 millimetres thick, the plurality of holes 14 have a diameter of between 2 and 12 millimetres and the hole surface area to panel surface area ratio should be between 0.03 and 0.30. Each of the plurality of through holes 14 need not have the same diameter.

The inner surface 17 of the panel 12, on the opposite side to the outer surface 15, can optionally be covered by a layer 18 of either acoustically reflective or acoustically absorptive material. Examples of such materials are open cell foams, mineral wool, fibrous materials, aluminum wool or glass fiber for instance and heavy mass layer or plastic sheet respectively. Such a layer can have any thickness. The advantage of this layer 18 is that noise from outside the interior of the vehicle may be blocked from entering the vehicle or may be absorbed before entering the interior compartment of the vehicle. The layer 18 need not be in contact with the panel 12 but may be in spaced apart relation from it.

In the embodiment illustrated in FIG. 1, the member 10 is attached to a door panel 20 of a vehicle via fasteners 22 such that said covering 16 faces away from said door panel. As will be clear to the skilled person, the member 10 could be attached in several other ways to door panel 20.

The member 10 attached to a door panel as illustrated in FIG. 2 is in accordance with the present invention. In this embodiment, which is the same as that shown in FIG. 1, the member 10 is arranged such that there are a plurality of through-holes 14 over the majority, but not all, of the door panel 20. In the illustrated embodiment certain areas 24 are reserved for attachments, such as door handles, ashtrays etc., to the door.

In the embodiment illustrated in FIG. 3, a floor carpet 40 for a vehicle is illustrated in which accessory mats 44 are placed on top of the floor carpet 40 in the regions of high wear. The accessory mats 44 are comprised of members according to the present invention. Floor mats 44 are individually placed in the floor wells of the car to avoid excess wear of the floor covering 40. In the illustrated embodiment, the floor mats 44 are comprised of members according to the present invention and include a plurality of through-holes 14 to adjust the acoustic response of the interior of the vehicle. The acoustic response can be varied by placing different accessory mats 44 in the vehicle with different hole densities, diameters and/or mat thicknesses.

The mechanism by which the present invention works through a combination of Helmholtz Resonator and spring-mass absorber system (air or insulation material) and plastic layers. The formula which governs the resonant frequency (ƒ₀) of a Helmholtz resonator is:

$${f}_{0} = \frac{c}{2 π} \sqrt{\frac{S}{V ( l + Δ l )}}$$

where c is the speed of the sound waves, S is the surface area of the opening, V is the volume of the cavity, l is the length of the opening i.e. distance from the outside surface to the cavity and Δl is a constant characteristic of the opening. Since the wavelength l of lower frequency noises is too long to have a Helmholtz quarter wave behind plastic panels, absorptive material can absorb more frequencies in a fraction of the thickness required in air alone.

FIG. 4 is a graph showing the acoustic absorption of a typical side panel insulator (door) for the interior of a vehicle with varying frequency. The curves were measured by placing three different door panels in a reverberation room one after another and playing random white noise into the room and measuring the reverberation time. The bottom curve in the Figure is for a door panel of the prior art, i.e. a panel (injection moulded plastic) covered by a non-woven fabric covering. The middle line is the response for the same panel and covering but with holes drilled in the panel, i.e. a member in accordance with the present invention. As can be seen, in a frequency range of between 400 and 2000 Hz, the side panel comprised of a member according to the present invention has a significantly improved absorption coefficient over the prior art. It is this frequency, range which is of interest since that range of frequencies is within the sensitivity of the human ear.

As well as absorbing more sound than the prior art, the member gives a flatter frequency response, meaning that when sounds are reflected, a more constant fraction of each frequency is reflected. This is important if the occupant of the vehicle is listening to music since a flatter frequency response of the panels will result in less distortion of the music because all frequencies will be reflected to the same extent.

The data values shown in FIG. 4 are for a member with holes of 3.3 mm diameter, a panel thickness of 5 mm and a hole surface area to panel surface area ratio within the range of 0.03 to 0.3.

The top line in FIG. 4 is for a covering and panel as in the middle line, but with a foam backing layer attached to the panel on the side opposite the covering. As can be seen, this absorptive layer further improves the absorbing properties of the door panel. As will be appreciated by the skilled person, the member of the present invention can be used in any components in the interior of a car. The two examples given are for a side panel insulator of a door and a floor mat of a car. However, the instrument panel, the back of the seats, shelves, pillars and centre console can all be made of a member according to the present invention whilst retaining their visual impact. Also panels may be attached outside of the passenger space such as on the outerside of the underbelly or in the trunk.

1. A means of transport including a passenger space defined by enclosure walls, said means of transport further comprising a panel having a plurality of through-holes formed therein from an outer surface to an inner surface of said panel;
said panel being attached to one of said enclosure walls in spaced apart relationship such that said outer surface faces away from said one of said enclosure walls.

2. The means of transport of claim 1, wherein said panel is attached inside said passenger space.

3. The means of transport of claim 1, wherein said panel is attached outside of said passenger space.

4. The means of transport of claims 1, 2 or 3 wherein said panel further comprises a covering of acoustically absorptive material covering said outer surface of said panel and said through-holes.

5. The means of transport of claims 1, 2 or 3, wherein said panel further comprises a covering of acoustically absorptive material covering said inner surface of said panel and said through holes.

6. The means of transport of any one of claims 1 to 5, further comprising an absorptive layer of acoustically absorptive material covering said inner surface of said panel and said through-holes.

7. The means of transport of any one of the preceding claims, further comprising a layer of acoustically reflective material covering said inner surface of said panel and said through-holes.

8. The means of transport of any one of the preceding claims, wherein said plurality of through-holes formed in said panel have a diameter of between 2 and 12 millimetres.

9. The means of transport of any one of the preceding claims, wherein the hole surface area to panel surface area ratio should be between 0.03 and 0.30 of said plurality of through-holes formed in said panel.

10. The means of transport of any one of the preceding claims, wherein said panel thickness is between 1 and 8 millimetres.

11. A means of transport according to any one of the preceding claims, wherein said panel is an inside panel for a door of a vehicle.

12. A means of transport according to any one of claims 1 to 10, wherein said panel is a back panel of a seat.

13. A means of transport according to any one of claims 1 to 10, wherein said panel is an accessory mat.

14. A means of transport according to any one of claims 1 to 10, wherein said one of said enclosure walls is the underbelly of said means of transport.
